(19) United States
(12) Patent Application Publication
(10) Pub. No.: US 2012/0133612 A1
(43) Pub. Date: May 31, 2012

(54) SWITCHABLE TOUCH DISPLAY DEVICE AND OPERATING METHOD THEREOF

(75) Inventors: Chih-Haw Wang, New Taipei City (TW); Pei-Hsun Wu, Zhongli City (TW)

(73) Assignee: BENQ MATERIALS CORP., Gueishan Township (TW)

(21) Appl. No.: 13/305,372

(22) Filed: Nov. 28, 2011

(30) Foreign Application Priority Data
Nov. 30, 2010 (TW) 99141557

(51) Int. Cl. G06F 3/045

(52) U.S. Cl. 345/174

(57) ABSTRACT

A switchable touch display device comprises at least one pixel unit and one controlling module. The pixel unit comprises first and second substrate disposed in parallel, a spacer, a common electrode and a data line. The spacer is disposed in the pixel unit and on the first substrate, and a gap formed between the first spacer and the second substrate. The common electrode is disposed on the first substrate and the spacer. The data line is disposed on the second substrate and part of it is disposed right under the spacer. The controlling module switches the pixel unit between a display mode and a touch mode. The controlling module controls the pixel unit to present with a predetermined luminance in the display module, and determine whether the spacer be pressed by external force to electrically contact common electrode and data line in the touch mode.

This application claims the benefit of Taiwan application Serial No. 099141557, filed Nov. 30, 2010, the subject matter of which is incorporated herein by reference.

### BACKGROUND OF THE INVENTION

1. Field of the Invention

The invention relates in general to a switchable touch display device and an operating method thereof, and more particularly to a switchable touch display device having a spacer and an operating method thereof.

2. Description of the Related Art

With the progress of technology, the display in the commercial market is not only for image display but also provided with touch function in order to satisfy the desires of the user. By the design of touch function, the display becomes more user-friendly, and the operation of the display is more intuitively easy and convenient. Traditional display has the touch function by additional infrared module or resistive module. Since extra elements such as infrared module or resistive module are required, the cost of product is higher and the process of production is more complex.

### SUMMARY OF THE INVENTION

The invention is directed to a switchable touch display device and operating method thereof, which adopts suitable spacers and circuit design to enable the display device possesses both of touch and display functions.

According to an aspect of the present invention, a switchable touch display device is provided. The switchable touch display device comprises at least a first pixel unit and a controlling module. The first pixel unit comprises a first substrate, a second substrate, a first spacer, a common electrode, a first data line. The second substrate is substantially disposed parallel to the first substrate. The first spacer is disposed in the first pixel unit and disposed on the first substrate, wherein there is a gap between the first spacer and the second substrate. The common electrode is disposed on the first substrate and the first spacer. The first data line is disposed on the second substrate and part of the first data line is disposed substantially right under the first spacer. The controlling module switches the first pixel unit operated in a display mode or in a touch mode. The controlling module controls a first voltage value of the first data line to enable the first pixel unit present with a first predetermined luminance in the display module, and the controlling module receives the first voltage value to determine whether the first spacer is pressed by an external force to enable the common electrode and the first data line electrically contact in the touch mode.

According to another aspect of the present invention, an operating method of a switchable touch display device is provided. The switchable touch display device comprises a pixel unit including a common electrode and a data line in the pixel unit. There is a gap between the common electrode and the data line. In operation, the switchable touch display device can be switched between a display mode and a touch mode. A voltage value of the data line is controlled to enable the pixel unit present with a predetermined luminance when the switchable touch display device is in the display mode. The voltage value is received when the switchable touch display device is in the touch mode. Whether the common electrode and the data line electrically contact is determined according to the voltage value. The switchable touch display device is defined as being pressed when the common electrode and the data line electrically contact. The switchable touch display device is defined as being not pressed when no electrically contact occurs between the common electrode and the data line.

The above and other aspects of the invention will become better understood with regard to the following detailed description of the non-limiting embodiment(s). The following description is made with reference to the accompanying drawings.

### BRIEF DESCRIPTION OF THE DRAWINGS

FIG. 1A shows the cross-sectional view of the pixel unit of the switchable touch display device not be pressed according to the embodiment of the disclosure.

FIG. 1B shows the cross-sectional view of the pixel unit of the switchable touch display device be pressed according to the embodiment of the disclosure.

FIG. 2 is a top view showing the pixel unit of the switchable touch display device according to the embodiment of the disclosure.

FIG. 3A shows the circuit diagram of the pixel of the switchable touch display device in the display mode.

FIG. 3B shows the circuit diagram of the pixel of the switchable touch display device in the touch mode.

FIG. 4 shows circuit diagram of several pixel units of the switchable touch display device according to the embodiment of the disclosure.

FIG. 5 shows the flow chart of the operation method of the switchable touch display device according to the embodiment of the disclosure.

### DETAILED DESCRIPTION OF THE INVENTION

### First Embodiment

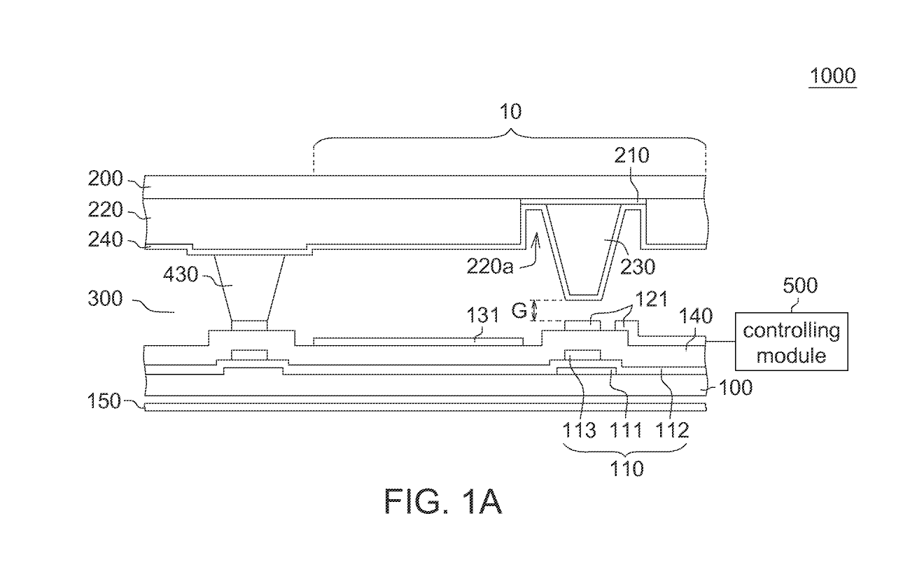

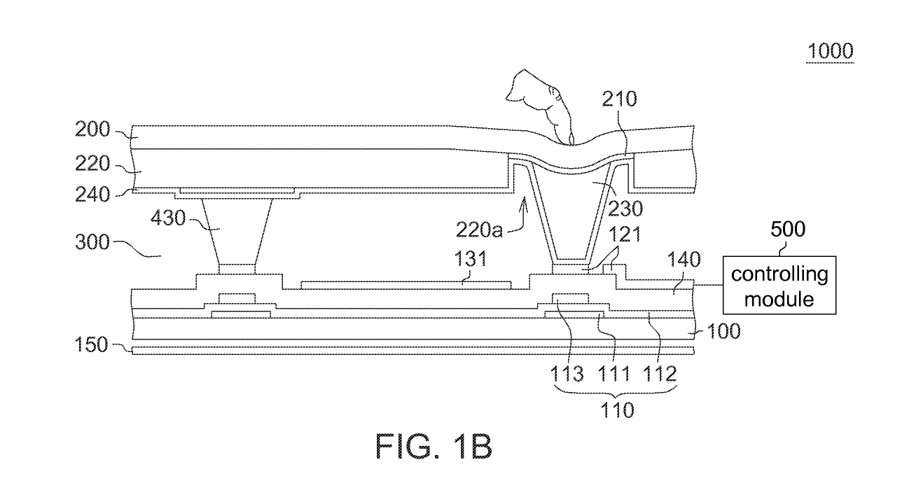

Please refer to FIG. 1A, which is a cross-sectional view of the pixel unit of a switchable touch display device not being pressed according to the embodiment of the disclosure. The switchable touch display device 1000 includes at least a pixel unit 10. The pixel unit 10 includes the second substrate 100, the first substrate 200 and the liquid crystal layer 300. The second substrate 100, for example, is an array substrate, and the first substrate 200, for example, is a color filter substrate. The liquid crystal layer 300 is sandwiched between the second substrate 100 and the first substrate 200. The liquid crystal molecules of the liquid crystal layer 300 rotate according to the electric filed between the second substrate 100 and the first substrate 200.

The thin film transistor 110, the first data line 121, the pixel electrode 131, the protective layer 140 and the backlight unit 150 are disposed on the second substrate 100. The thin film transistor 110 is disposed on the second substrate 100 and electrically coupled to the first data line 121 and the pixel electrode 131. The thin film transistor 110 controls whether the voltage of the first data line 121 is applied to the pixel electrode 131. The protective layer 140 is disposed on the thin film transistor 110. The first data line 121 and the pixel electrode 131 are disposed on the protective layer 140. The voltage value of the pixel electrode 131 controls the rotation direction of the liquid crystal molecules in the liquid crystal layer 300. The backlight unit 150 is used to emit light which goes through the second substrate 100, the liquid crystal layer 300 and the first substrate 200 sequentially.

In the embodiment, the thin film transistor 110 includes the gate layer 111, the insulated layer 112 and the semiconductor layer 113. The semiconductor layer 113 is electrically coupled to the first data line 121 and the pixel electrode 131. The gate layer 111 could be metal. The voltage value of the gate layer 111 could be used to control whether an electrical channel is formed between the first data line 121 and the pixel electrode 131. The insulated layer 112 is disposed on the gate layer 111 to prevent the gate layer 111 from contacting other conductive materials, thereby preventing from short circuit.

The black matrix 210, the color filter 220, the spacers 230 and the common electrode 240 are disposed on the first substrate 200. The color filter 220 is disposed on the first substrate 200. The color filter 220 has an accommodation member 220a which, for example, is a hole. The black matrix 210 is disposed on the first substrate 200 to improve the color contrast of the image of the switchable touch display device. The spacers 230 are disposed in the accommodation member 220a and on the black matrix 210. Part of the first data line 121 is substantially disposed right under the spacers 230. The common electrode 240 has a common voltage and is disposed on the black matrix 210, the color filter 220 and the spacers 230. There is a gap G between the common electrode 240 on the spacers 230 and the first data line 121 on the second substrate 100. The length of the gap G is substantially between 0.1 μm and 0.4 μm. In another embodiment, the length of the gap G is substantially between 0.2 μm and 0.3 μm. Besides, the switchable touch display device 1000 further includes spacers 430. The spacers 430 are disposed between the first substrate 200 and the second substrate 100. The spacers 430 are used to support the first substrate 200 and the second substrate 100 to separate the first substrate 200 from the second substrate 100. Further more, the upper end and the lower end of the spacers 430 are against the common electrode 240 and the first data line 121 respectively, to maintain a particular distance between the first substrate 200 and the second substrate 100.

In the embodiment, the switchable touch display device 1000 further includes a controlling module 500. The controlling module 500 is used to switch the pixel unit 10 in a display mode or in a touch mode. The controlling module 500 could control the voltage value of the first data line 121 in the display mode. The voltage of the first data line 121 is applied to the pixel electrode 131 by the thin film transistor 110. The pixel unit 10 presents with a predetermined luminance according to the rotation direction of the liquid crystal molecules of the liquid crystal layer 300 depending on the voltage difference between the pixel electrode 131 and the common electrode 240.

On the other hand, the controlling module 500 could receive the voltage value of the first data line 121 in the touch mode, so as to determine whether the common electrode 240 electrically contacts the first data line 121 by an external force applying on the spacers 230. Please refer to FIG. 1A and FIG. 1B, which are the cross-sectional views showing the pixel unit of the switchable touch display device not being pressed and being pressed respectively according to the embodiment of the disclosure. As shown in FIG. 1A, when the first substrate 200 is not pressed, there is a gap G between the common electrode 240 on the spacers 230 and the first data line 121, thus the common electrical potential of the common electrode 240 cannot be applied to the first data line 121. On the other hand, as shown in FIG. 1B, when the first substrate 200 is pressed by an external force, the common electrode 240 on the spacers 230 is electrically coupled to the first data line 121 to enable the common voltage be applied from the common electrode 240 to the first data line 121. Therefore, whether the common electrode 240 on the spacers 230 is electrically coupled to the first data line 121 or not will affect the voltage value of the first data line 121 received by the controlling module 500. Thus, the controlling module 500 can determine whether the first substrate 200 be pressed or not according to the voltage value received by the first data line 121.

In an embodiment, at least one spacer 230 is disposed in the switchable touch display device 1000 per square centimeter as a touch point for user to operate when the pixel unit 10 is in the touch mode. On average, 3 spacers (may including spacers 230 or 430) are disposed within nine pixels 10. In an embodiment, the number of the spacers 430 is substantially at least 1/15 of the sum of the numbers of the spacers 230 and spacers 430.

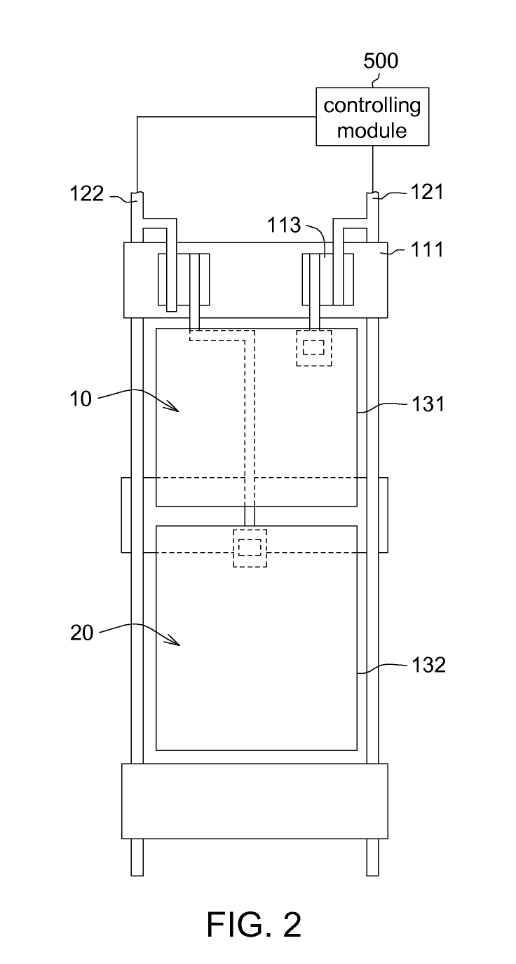

In an embodiment, the pixel unit 10 described above may be applied in the wide viewing angle liquid crystal displays. Each pixel of the wide viewing angle LCD could be divided into two domains, and the different pre-tilted angle could be designed for the liquid crystal molecules in these two domains to achieve wide viewing angle effect. Please refer to FIG. 2, which is a top view of the pixel units of the switchable touch display device according to the embodiment of the disclosure. In FIG. 2, two domains are pixel units 10 and 20, respectively. In the touch mode, the pixel unit 10 could be used for determining whether the switchable touch display device 1000 is pressed or not while the pixel unit 20 could be used to display. In the display mode, the pixel units 10 and 20 are used to display. Thus, no matter the switchable display touch device 1000 is in the touch mode or in the display mode, it still maintains the display function.

In FIG. 2, the second data line 122, the transistor (not shown) and the pixel electrode 132 are disposed in the pixel unit 20. The way that the pixel unit 20 operated in the display mode is similar to the way that the pixel unit 10 operated in the display mode, thus it will not be described repeatedly.

In the embodiment, since no display of the pixel unit 10 in the touch mode, the ratio of the area of the pixel unit 10 to the area of the pixel unit 20 has effect on the luminance of the switchable touch display device 1000 in the touch mode. For example, if the area of the pixel unit 10 is much larger than the area of the pixel unit 20, the luminance of the switchable touch display device 1000 would be decreased greatly in the touch mode. If the area of the pixel unit 10 is much smaller than the area of the pixel unit 20, the luminance of the switchable touch display device 1000 would be decreased slightly in the touch mode. In an embodiment, the ratio of the area of the pixel unit 20 to the area of the pixel unit 10 in the switchable touch display device 1000 is between about 0.7 to 2.5.

In the embodiment, the luminance of the switchable touch display device 1000 could be adjusted by dynamic gray scale correction or luminance adjustment of the backlight 150 (shown in the FIG. 1A) to enable the luminance of the switchable touch display device 1000 in the display mode be substantially the same as that in the touch mode. For example, the controlling module 500 controls the voltage value of the second data line 122 in the touch mode higher than the voltage value of the second data line 122 in the display mode to enable the presented luminance of the pixel unit 20 in the touch mode be higher than the presented luminance of the pixel unit 20 in the display mode. Alternatively, for example, the controlling module 500 controls the brightness of the backlight 150 in the touch mode to be higher than the brightness of the backlight 150 in the display mode.

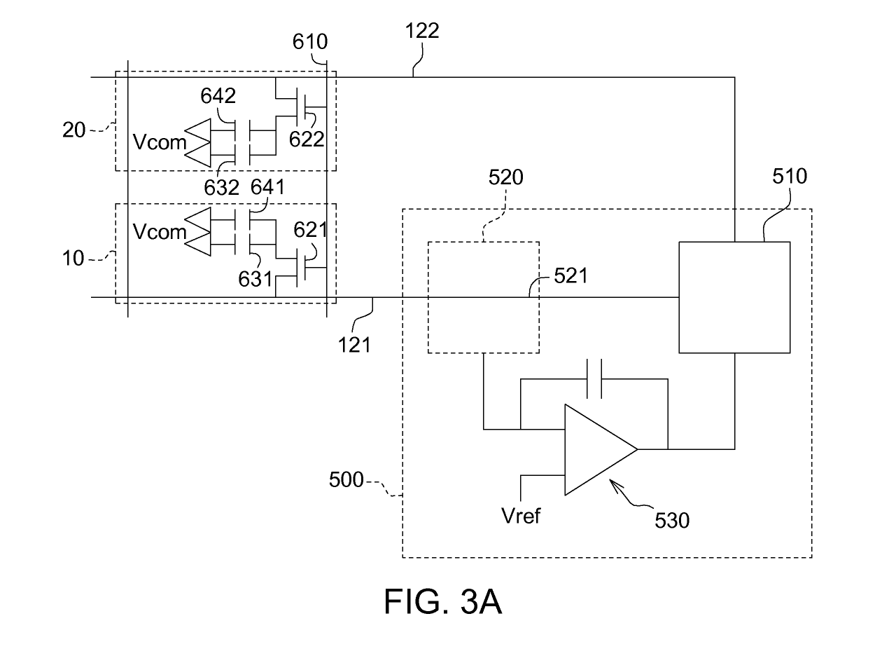

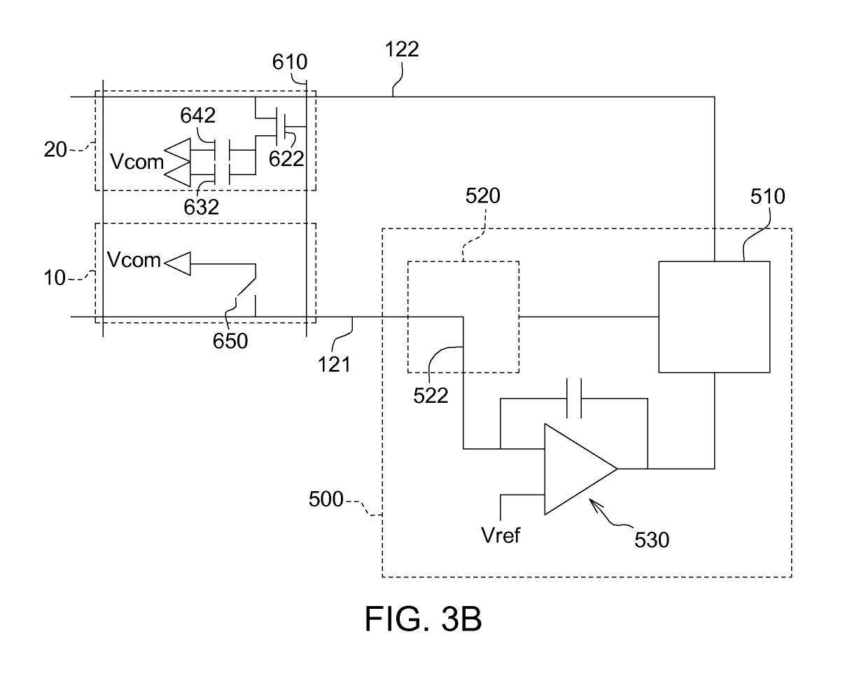

To further explain the circuit diagram of the pixel units 10 and 20 in the display mode, please refer to FIG. 3A which shows the circuit diagram of the pixel of the switchable touch display device in the display mode. The controlling module 500 includes the controlling unit 510, the switching unit 520 (presented by the dash line, in order to clearly show the inner electrical channel) and the integral unit 530. The switching unit 520 is coupled to the first data line 121. The controlling unit 510 is electrically coupled to the integral unit 530 and the first data line 121. In FIG. 3A, the first data line 121, the scan line 610, the transistor 621, the liquid crystal capacity 631 and the storage capacity 641 are disposed in the pixel unit 10. The transistor 621 controls whether the voltage of the first data line 121 is applied to the liquid crystal capacity 631 and the storage capacity 641 or not, according to the voltage of the gate that is input by the scan line 610. In the display mode, the controlling unit 510 controls the switching unit 520 to create a first electrical channel 521 between the first data line 121 and the controlling unit 510. The controlling unit 510 controls the voltage value of the first data line 121 by the first electrical channel 521. The voltage value of the first data line 121 is applied to the liquid crystal capacity 631 and the storage capacity 641 by the transistor 621 to enable the first pixel unit 10 present with the predetermined luminance. On the other hand, the second data line 122, the scan line 610, the transistor 622, the liquid crystal capacity 632 and the storage capacity 642 are positioned in the pixel unit 20. The second data line 122 of the pixel unit 20 is directly electrically coupled to the controlling unit 510. Other parts are similar to the pixel unit 10, and it is thus not described repeatedly.

In order to describe the circuit diagram when the pixel units 10 and 20 are operated in the touch mode, please refer to FIG. 3B which shows the circuit diagram of the pixel of the switchable touch display device in the touch mode. The switching element 650 is disposed in the pixel unit 10. One end of the switching element 650 is common potential and the other end of the switching element 650 is electrically coupled to the first data line 121. When the switching element 650 is breaking, the common potential can not be transferred to the first data line 121. As shown in FIG. 1A, the common electrode 240 on the spacers 230 is not electrically coupled to the first data line 121, so that the common potential can not be transferred to the first data line 121. On the other hand, when the switching element 650 is on, the common potential could be transferred to the first data line 121. As shown in FIG. 1B, the common electrode 240 on the spacers 230 is electrically coupled to the first data line 121 to enable the common potential be transferred to the first data line 121.

Please refer to FIG. 3B, the controlling unit 510 could control the switching unit 520 to create a second electrical channel 522 between the first data line 121 and the integral unit 530. The controlling unit 510 receives the voltage of the first data line 121 by the second electrical channel 522. The voltage value is transferred from the first data line 121 to the integral unit 530 by the second electrical channel 522. Compared the voltage of the first data line 121 (detected by the integral unit 530) and the Vref, the integral unit 530 transmits a signal to the controlling unit 510. Conditions of the switching element 650 (i.e. on or off) have effects on whether the common voltage is transferred to the first data line 121 or not and the voltage value transferred to the controlling unit 510. The controlling unit 510 is able to determine whether the switchable touch display device 1000 is pressed by an external force according to the voltage value.

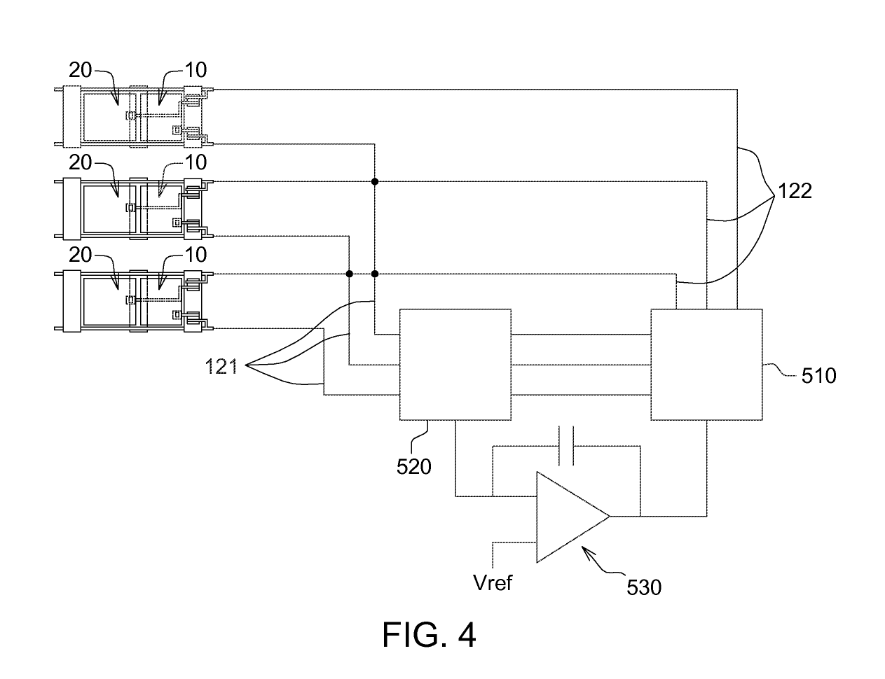

Please refer to FIG. 4, which shows circuit diagram of several pixel units of the switchable touch display device according to the embodiment of the disclosure. In the embodiment, the first data lines 121 of each pixel unit 10 are electrically coupled to the switching unit 520. According to the order of the controlling unit 510, each pixel unit 10 is electrically coupled to the controlling unit 510 or the integral unit 530 selectively by the switching unit 520 to let the pixel unit 10 be operated in the display mode or in the touch mode. The pixel unit 20 is electrically coupled to the controlling unit 510 and operated in the display mode.

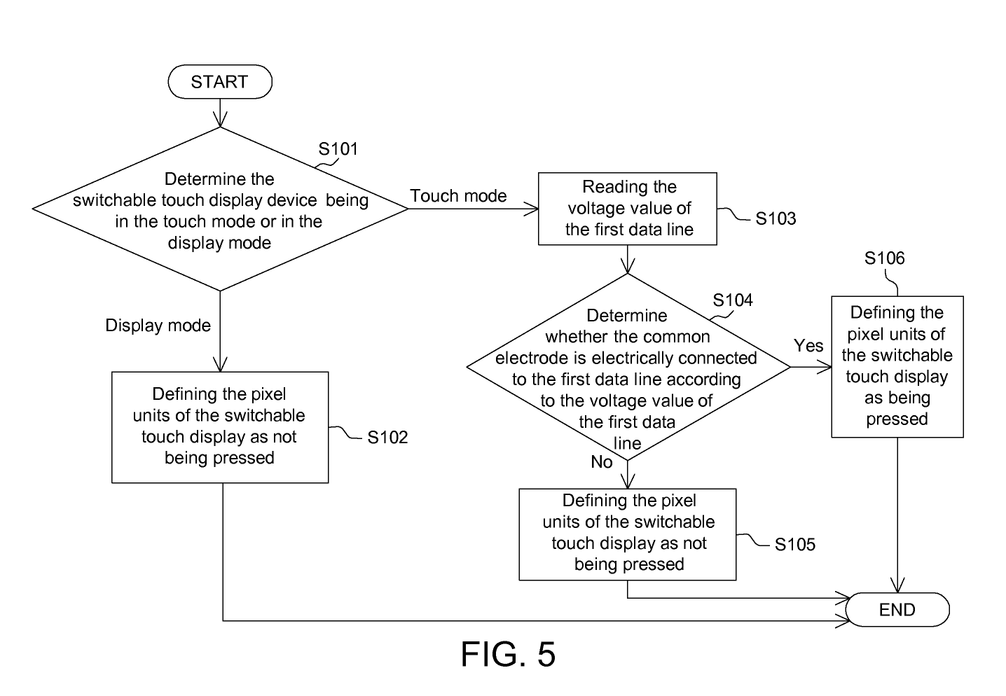

The operation method of each element disclosed above is further described below with a flow chart. However, the flow chart is not limited to be applied to the elements described above. Please refer to FIG. 5 which shows a flow chart of the operation method of the switchable touch display device according to the embodiment of the disclosure.

First, in step S101, the switchable touch display device 1000 in the touch mode or in the display mode is determined. If the switchable touch display device 1000 is in the display mode, the pixel unit of the switchable touch display is defined as not being pressed, as in step S102. If the switchable touch display device 1000 is in the touch mode, the controlling module 500 receives the voltage value of the first data line 121, as in step S103.

In step S102, the controlling module 500 controls the voltage value of the first and the second data line 121, 122 to enable the pixel units 10, 20 present with predetermined luminance.

In step S103, the controlling module 500 receives the voltage value of the first data line 121.

Then, in step S104, whether the common electrode 240 is electrically coupled to the first data line 121 is determined according to the voltage value of the first data line 121. If the common electrode 240 is not electrically coupled to the first data line 121, step S105 is executed; if the common electrode 240 is electrically coupled to the first data line 121, step S106 is executed.

In step S105, the pixel unit 10 of the switchable touch display device 1000 is defined as not being pressed. In the step S106, the pixel unit 10 of the switchable touch display device 1000 is defined as being pressed.

Additional cost of elements for using infrared ray mode or resistive mode to detect the touch point is required for constructing the traditional display. The structure of the embodiment provided herein possesses the functions of display and touch by utilizing the elements originally owned by the display itself and incorporated with the controlling module. For example, instead of being attached to both of the first substrate and the second substrate for separation, the spacers of the embodiment are attached to one of the first substrate and the second substrate and spaced apart from the other one. Also, the common electrode is disposed on the spacers. When the substrate is pressed by an external force, the common voltage of the common electrode is transferred to the controlling module to determine if the substrate is pressed by the external force.

While the invention has been described by way of example and in terms of the embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A switchable touch display device, comprising:
at least a first pixel unit, comprising:
a first substrate;
a second substrate substantially disposed parallel to the first substrate;
a first spacer disposed in the first pixel unit and disposed on the first substrate, wherein there is a gap between the first spacer and the second substrate;
a common electrode disposed on the first substrate and the first spacer; and
a first data line disposed on the second substrate and part of the first data line disposed substantially right under the first spacer; and
a controlling module for switching the first pixel unit operated in a display mode or in a touch mode, wherein the controlling module controls a first voltage value of the first data line to enable the first pixel unit present with a first predetermined luminance in the display module, and the controlling module receives the first voltage value to determine whether the first spacer be pressed by an external force to enable the common electrode contact the first data line electrically in the touch mode.

2. The switchable touch display device according to claim 1, further comprising:
at least a second pixel unit comprising:
a second data line disposed in the second pixel unit;
wherein the controlling module controls a second voltage value of the second data line to enable the second pixel unit present with a second predetermined luminance.

3. The switchable touch display device according to claim 2, wherein a ratio of the area of the second pixel unit to the area of the first pixel unit is between 0.7 and 2.5.

4. The switchable touch display device according to claim 2, wherein the second voltage value in the touch mode controlled by the controlling module is higher than the second voltage value in the display mode.

5. The switchable touch display device according to claim 1, wherein the controlling module comprises:
an integral unit;
a switching unit coupled to the first data line; and
a controlling unit electrically coupled to the integral unit and the first data line, the controlling unit controls the switching unit to enable the switching unit form a first electrical channel between the first data line and the controlling unit, or form a second electrical channel between the first data line and the integral unit selectively,
wherein the controlling unit controls the first voltage value by the first electrical channel;
the controlling unit receives the first voltage value by the second electrical channel.

6. The switchable touch display device according to claim 1, further comprising:
a backlight unit, wherein the luminance of the backlight unit in the touch mode is controlled to be higher than the luminance of the backlight unit in the display mode by the controlling module.

7. The switchable touch display device according to claim 1, further comprising:
a color filter disposed on the first substrate and having an accommodation member in which the first spacer is disposed.

8. The switchable touch display device according to claim 1, further comprising:
a second spacer disposed between the first substrate and the second substrate to separate the first substrate and the second substrate;
wherein the number of the first spacers is substantially at least 1/15 of the sum of the number of the first spacers and the second spacers.

9. The switchable touch display device according to claim 1, wherein a length of the gap is substantially between 0.1 μm and 0.4 μm.

10. An operating method of a switchable touch display device, the switchable touch display device comprising a pixel unit including a common electrode and a data line in the pixel unit, and a gap between the common electrode and the data line, the operating method comprising:
switching the switchable touch display device in a display mode or a touch mode;
controlling a voltage value of the data line to enable the pixel unit present with a predetermined luminance when the switchable touch display device is in the display mode;
receiving the voltage value when the switching touch display device is in the touch mode;
determining whether the common electrode and the data line are electrically contacted according to the voltage value;
defining the switchable touch display device being pressed when the common electrode and the data line are electrically contacted; and
defining the switchable touch display device not being pressed when the common electrode and the data line are not electrically contacted.
